(19) United States
(12) Patent Application Publication
(10) Pub. No.: US 2013/0099024 A1
(43) Pub. Date: Apr. 25, 2013

(54) Spraying Device With Interchangeable Cartridge

(71) Applicants: Brian Birrenkott, Dublin, OH (US); Paul Havlovitz, Dublin, OH (US); Steve Cichy, Marysville, OH (US); Michael Cavins, Marysville, OH (US); Jon Moyer, Columbus, OH (US)

(72) Inventors: Brian Birrenkott, Dublin, OH (US); Paul Havlovitz, Dublin, OH (US); Steve Cichy, Marysville, OH (US); Michael Cavins, Marysville, OH (US); Jon Moyer, Columbus, OH (US)

(73) Assignee: OMS Investments, Inc., Los Angeles, CA (US)

(21) Appl. No.: 13/524,827

(22) Filed: Jun. 15, 2012

Related U.S. Application Data
(62) Division of application No. 12/797,415, filed on Jun. 9, 2010, now Pat. No. 8,235,310.
Application No. 12/797,415 is a continuation of application No. 11/368,963, filed on Mar. 6, 2006, now abandoned.
Application No. 11/368,963 is a continuation of application No. 10/712,970, filed on Nov. 13, 2003, now Pat. No. 7,156,324.

(51) Int. Cl. B05B 7/04

(52) U.S. Cl. CPC B05B 7/0408
USPC 239/318

(57) ABSTRACT

A spraying device is provided that includes a cartridge containing a first fluid, the cartridge being removably connected to a sprayer body. The cartridge is oriented such that gravity exerts a downward force on the first fluid. The sprayer body includes a conduit for receiving a second fluid. A valve is coupled to the conduit. The valve allows the second fluid to flow through the valve, thus creating a Venturi vacuum that draws the first fluid out of the cartridge and into the valve to enable the first and second fluids to mix and form an outlet stream. An orifice meters a predetermined amount of the first fluid into the valve to achieve a predetermined ratio of the first fluid to the second fluid. The outlet stream is then dispensed from a spray nozzle.

### FIELD OF THE INVENTION

The present invention relates to a spraying device and more particularly to a spraying device that includes a sprayer body, a cartridge containing a first fluid, the cartridge being oriented such that gravity exerts a downward force on the first fluid, and a valve for mixing a second fluid with the first fluid by creating a vacuum that draws the first fluid out of the cartridge, without the need for a dip tube, and into the valve thus enabling the first and second fluids to mix and be dispensed.

### BACKGROUND OF THE INVENTION

There are many known spraying devices for dispensing chemicals for lawn and garden applications. Typical spraying devices include a sprayer body connected to a container filled with a fluid (e.g., a concentrated chemical) and connected to a water hose. The fluids are mixed and dispensed via a spray head. Typical sprayers include a dip tube that extends downwardly into the container. The dip tube provides a direct passageway between the fluid in the container and the sprayer body. The constant flow of water through the sprayer produces a vacuum that draws the fluid through the dip tube, mixes the fluid with the water and dispenses the mixture from the spray head. Typical sprayers also include sealed containers for storing the fluid to be dispensed. These containers can only be used with a spraying device, they can not be used to manually dispense the contained fluid.

Other known sprayers divert a portion of the water from a hose into a container connected to the sprayer body. The water mixes with the contents of the container, ding the container. The pressure of the mixture in the container forces the mixture out of the container, into the sprayer body, and out the spray head.

However, there are drawbacks to the known sprayers, including complex construction and the inability to manually select the amount of chemical mixed with water. Therefore, a need exists for a spraying device that is capable of mixing a predetermined or selected ratio of a first fluid with a second fluid without the need for a dip tube and without having to mix the fluids in the container.

It is desirable to provide an inexpensive cartridge that is interchangeable.

It is also desirable to provide a cartridge that is substantially simpler and more economical to produce.

It is desirable to provide a sprayer body that is durable and reusable multiple times.

It is also desirable to provide a cartridge that allows small amounts of fluid to be dispensed without the use of a sprayer.

It is desirable to provide a spraying device that allows a user to adjust the ratio of a first fluid that is mixed with a second fluid (e.g., water) via an adjustable metering selector.

It is also desirable to provide a spraying device that includes a metering orifice for mixing a predetermined amount of a first fluid with a second fluid.

### SUMMARY OF THE INVENTION

The present invention overcomes the disadvantages of the prior art by providing a spraying device that includes a cartridge containing a first fluid, the cartridge being removably connected to a sprayer body. The cartridge is oriented such that gravity exerts a downward force on the first fluid. The sprayer body includes a conduit for receiving a second fluid. A valve is coupled to the conduit. The valve allows the second fluid to flow through the valve, thereby creating a Venturi vacuum that draws the first fluid out of the cartridge and into the valve to enable the first and second fluids to mix and form an outlet stream. An orifice meters a predetermined amount of the first fluid into the valve to achieve a predetermined ratio of the first fluid to the second fluid in the outlet stream. The outlet stream may then be dispensed from a spray nozzle.

### BRIEF DESCRIPTION OF THE DRAWINGS

These and other features of the present invention will be more fully disclosed when taken in conjunction with the following Detailed Description of the Invention in which like numerals represent like elements and in which:

FIG. 1 shows a perspective view of one embodiment of a spraying device according to the present invention that includes a sprayer body and a cartridge.

FIG. 2 shows a perspective view of an assembled spraying device according to the present invention.

FIG. 3 shows a cross-sectional view of one embodiment of an assembled spraying device according to the present invention in the “feed” position.

FIG. 4 shows a cross-sectional view of one embodiment of an assembled spraying device according to the present invention in the “water only” position.

FIG. 5 shows a cross-sectional view of one embodiment of an assembled spraying device according to the present invention in the “off” position.

FIG. 6 shows an exploded view of one embodiment of a cartridge according to the present invention.

FIG. 7 shows a partial exploded view of another embodiment of a cartridge according to the present invention.

FIG. 8 shows an exploded view of one embodiment of a spraying device according to the present invention.

FIG. 9 shows a partial cross-sectional view of one embodiment of an assembled spraying device according to the present invention.

FIG. 10 shows a partial cross-sectional view of another embodiment of a sprayer body according to the present invention including an adjustable metering disc.

FIG. 11 shows a cross-sectional view of one embodiment of a sprayer body according to the present invention including an adjustable metering disc.

FIG. 12 shows a side view of another embodiment of a spraying device according to the present invention.

### DETAILED DESCRIPTION OF THE INVENTION

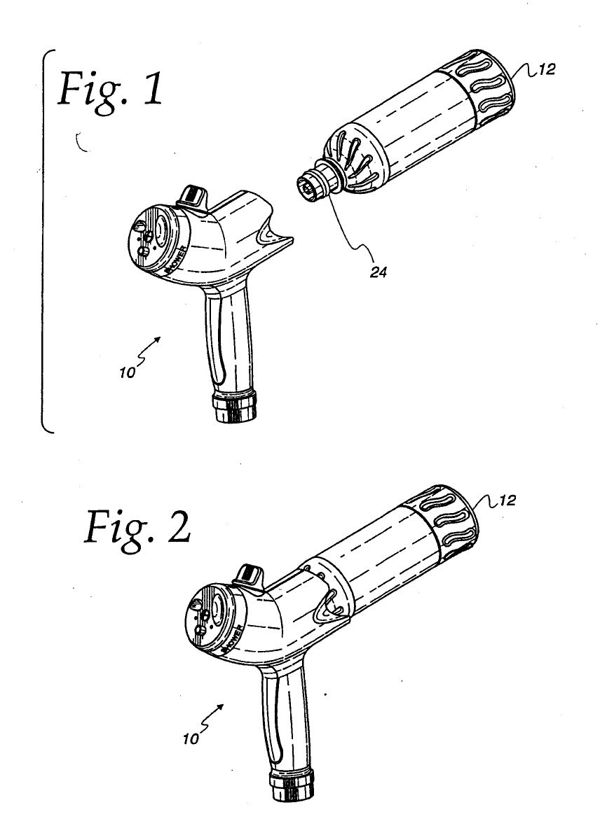

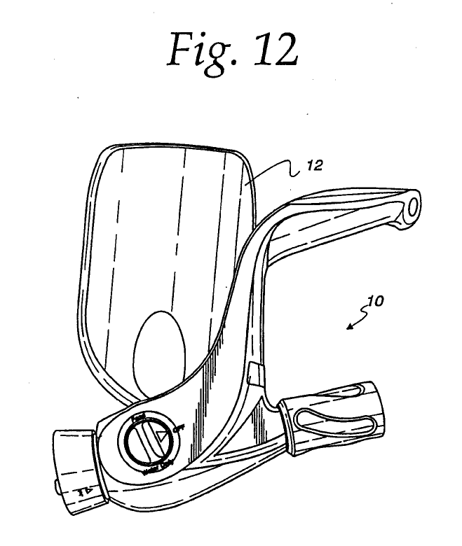

In one embodiment, a spraying device of the present invention generally includes two primary parts: a sprayer body 10 and a cartridge 12, as shown in FIGS. 1 and 2. The cartridge 12 is removably connected to the sprayer body 10 via threads 24, or other suitable connecting means, as shown in FIGS. 1-3. When the cartridge 12 is connected to the sprayer body 10, a first fluid 36 contained in the cartridge 12 flows into the sprayer body 10 and is mixed with a second fluid 37 (e.g., water) in valve 20, as explained below. The cartridge 12 can be made of flexible plastic, or any other suitable material. The cartridge 12 can have many different shapes and forms, including a flexible bottle, pouch or bag shape. An alternative cartridge design is illustrated in FIG. 12. The first fluid 36 may comprise liquid fertilizers, insecticides, herbicides, fungicides, mildewcides, nematicides, growth regulators, insect repellents, cleaning products, and the like.

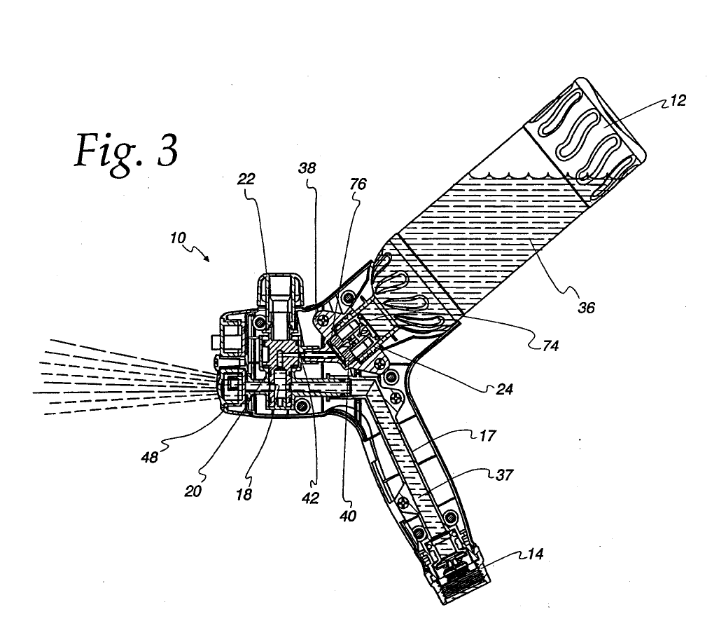

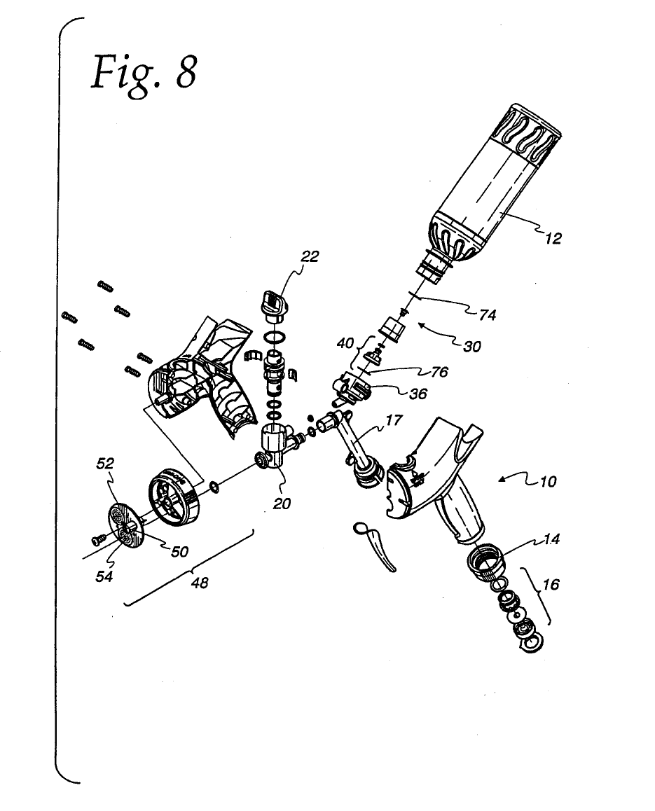

Referring to FIG. 3, fluid conduit 17 is disposed in the sprayer body 10, which can be constructed from any suitable material, such as plastic. A first end of fluid conduit 17 is coupled to hose coupler 14. The sprayer body 10 connects to a typical home water supply (e.g., a garden hose) at coupler 14. In one embodiment, the coupler 14 includes an anti-siphon unit 16 (shown in FIG. 8), which is well known in the art, for preventing or minimizing back flow and leaking from fluid conduit 17. A second end of fluid conduit 17 is coupled to a valve 20, which is coupled to spray nozzle 48. As used herein, the terms “connected” and “coupled” both mean connected directly or indirectly through intervening components.

In one embodiment, the valve 20 includes a valve knob 22 for rotatably selecting between three conditions: off, feed and water only. The valve 20 is coupled to and actuated by the valve knob 22. The valve 20 further includes a Venturi location 18 for creating a vacuum for siphoning the first fluid from the cartridge 12. When the valve knob 22 is in the “feed” position, the second fluid 37 (e.g., water) flows into the valve 20 creating a Venturi vacuum that draws the first fluid 36 out of the cartridge 12.

Specifically, the flow of the second fluid 37 through the valve 20 creates a vacuum therein. Because the cartridge 12 is oriented such that gravity exerts a downward force on the first fluid 36, the valve 20 is able to draw the first fluid 36 out of the cartridge 12 without the need for a dip tube. The first fluid 36 travels through cartridge adapter 38 and filter assembly 40. In one embodiment, the valve 20 includes a metering orifice 42 through which the first fluid flows into the valve 20 where it is mixed with the second fluid 37 at Venturi location 18. The mixture is then dispensed out of the spray nozzle 48. In one embodiment, the spray nozzle 48 is rotatably adjustable to provide different spray patterns via three different nozzle orifices: flat 50, jet 52 and shower 54, as shown in FIG. 8.

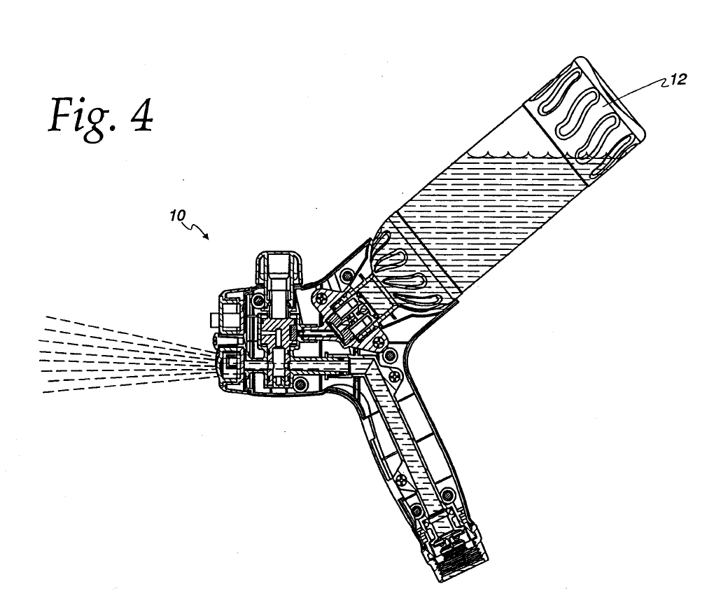

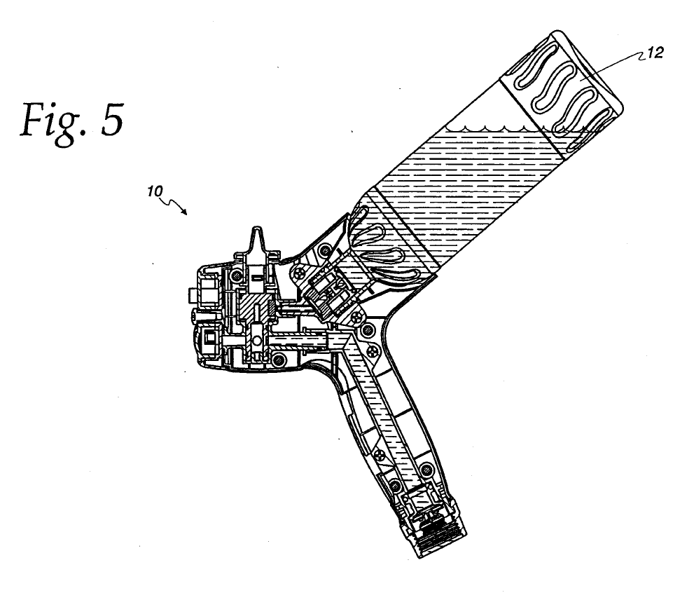

FIG. 3 shows the spraying device in the “feed” position, which mixes the two fluids and dispenses the mixture. FIG. 4 shows the spraying device in the “water only” position, which dispenses the second fluid 37 only. FIG. 5 shows the spraying device in the “off” position, which prevents either fluid from being dispensed.

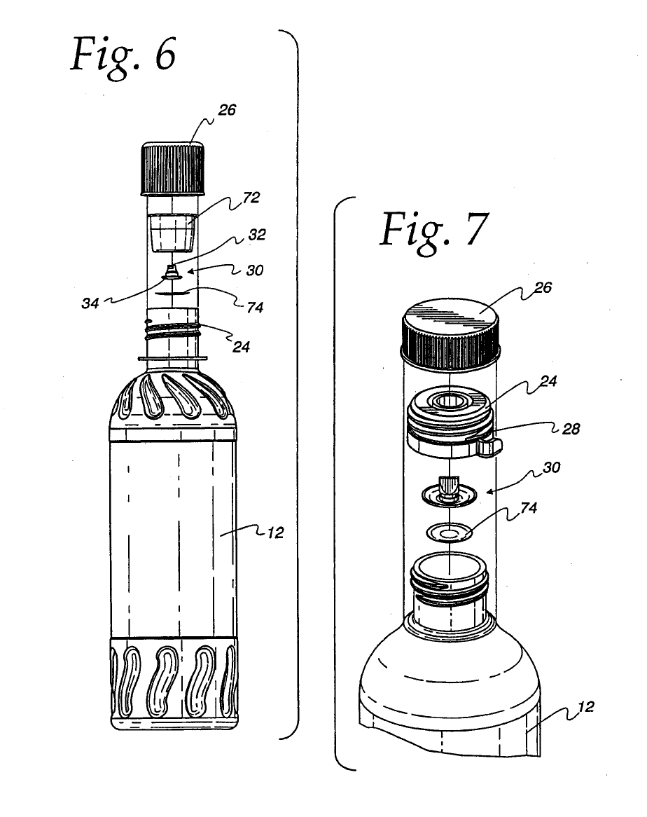

Referring to FIGS. 6 and 7, the cartridge 12 includes a two-way check valve 30 that keeps the cartridge sealed until the vacuum generated by the sprayer body 10 actuates the “duckbill” portion 32, which allows the first fluid 36 to be siphoned from the cartridge 12. Air is allowed back into the cartridge 12 via the “umbrella” portion 34 thus allowing proper venting and consistent mixing of the first fluid 36 with the second fluid 37 in the valve 20. The second fluid 37 does not enter the cartridge 12 during this process.

The check valve 30 allows the cartridge 12 to be removed from the sprayer body 10 at any time without leakage because the check valve 30 will return to a closed position when no vacuum is present. Another advantage of the cartridge 12 is that the first fluid can be manually dispensed from the cartridge 12 by squeezing the flexible cartridge 12 when it is in an inverted position. This allows a user to manually mix small quantities of the first fluid with a second fluid (e.g., water) in a bucket or watering can without the use of the sprayer body 10. This allows the first fluid to be distributed in small areas without the need for a garden hose. Previously known cartridges are sealed containers that can only be used with a corresponding spraying device.

In one embodiment, the cartridge 12 includes a cap 26 having threads that correspond to the threads 24 on the cartridge 12, as shown in FIG. 6. The cartridge 12 can be a sealed, non-refillable container, as shown in FIG. 6 or a refillable container that includes a secondary threaded closure 28, as shown in FIG. 7.

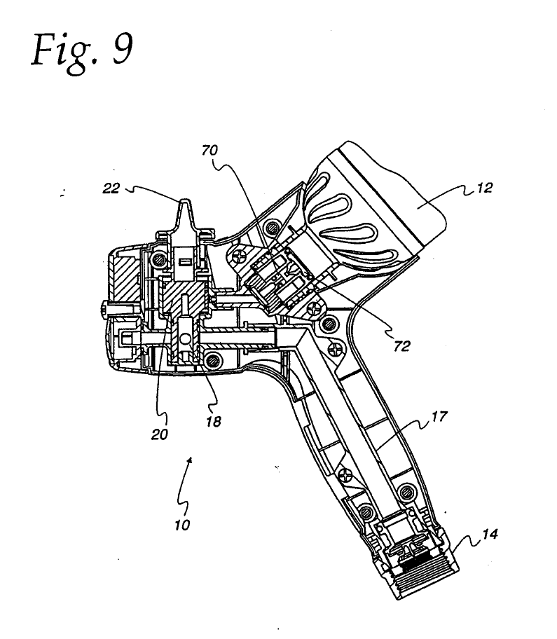

In one embodiment, fixed fluid metering is accomplished by including a metering orifice 70 within cartridge insert 72, as shown in FIG. 9. This allows mix ratio customization based on the particular fluid 36 contained within the cartridge 12. In another embodiment, the metering orifice 70 is included in the secondary threaded closure 28, as shown in FIG. 7. In both embodiments, cartridges containing different types of fluids can each have appropriately sized orifices to mix the proper ratio of the first fluid 36 with the second fluid 37. Providing the metering orifice within the cartridge 12 eliminates having to make or use different sprayers for different types of fluids.

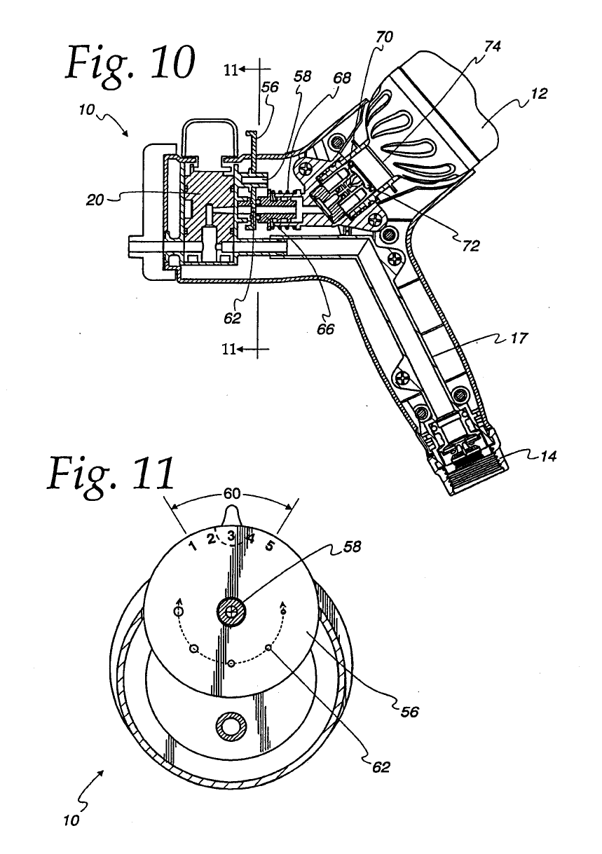

Variable fluid metering is accomplished by using an adjustable metering disc 56, as shown in FIGS. 10 and 11. The metering disc 56 rotates about axis 58. The disc 56 is manually rotated via a selector 60 that allows selection of one of several orifice sizes 62. The metering disc 56 is engaged against the valve 20 and a continuous seal is maintained by a floating plunger 66 that is kept against the metering disc 56 by a compression spring 68.

FIG. 10 shows a spraying device that includes both a fixed metering orifice 70 within the cartridge insert 72 and a variable metering disc 56 within the sprayer body 10. Any of the described fluid metering embodiments can be used independently or in conjunction with each other. The metering orifice determines the amount of the first fluid that is mixed with the second fluid so that a predetermined ratio of the first fluid to the second fluid can be dispensed in the outlet stream.

As shown in FIGS. 3, 6, 7, 8 and 10, fluid filters 74 and/or 76 may be included to assure that metering orifices 42 and/or 70 are kept open and functional.

An alternative embodiment of the spraying device is shown in FIG. 12. This embodiment includes a sprayer body 10 and cartridge 12 having different designs than the embodiment of FIGS. 1-2. However, the internal operation of this embodiment is generally the same as described above.

While particular embodiments of the invention have been shown and described in detail, it will be obvious to those skilled in the art that changes and modifications of the present invention, in its various embodiments, may be made without departing from the spirit and scope of the invention. Other elements, steps, methods and techniques that are insubstantially different from those described herein are also within the scope of the invention. Thus, the scope of the invention should not be limited by the particular embodiments described herein but should be defined by the appended claims and equivalents thereof.

1-32. (canceled)

33. A sprayer body, comprising:
a first conduit for receiving a first liquid from a cartridge removeably coupled to the sprayer body;
a second conduit for receiving a second liquid from an external source;
a valve structure, comprising a first liquid passageway and a second liquid passageway, configured such that the passage of the second liquid through the valve structure creates a reduced pressure that draws the first liquid out of the cartridge and into the valve structure without the need for a dip tube;
the first passageway communicating with the first liquid from the first conduit and the second passageway communicating with the second liquid from the second conduit,
a manual actuator positioned in operative relationship with the valve structure enabling movement of the valve structure between three discrete positions comprising:
a) a first position enabling the second liquid to flow through the valve structure to create a reduced pressure in the valve structure which draws the first liquid out of the cartridge and into the valve structure wherein the first and the second liquids mix to form an outlet stream which flows through the valve structure;
b) a second position enabling only the second liquid to flow through the valve structure and blocking the flow of the first liquid through the valve structure, and
c) a third position blocking the first and the second liquids from flowing through the valve structure; and
an orifice for metering a predetermined amount of the first liquid from the cartridge into the valve structure in the first position to achieve a predetermined ratio of the first liquid to the second liquid in the outlet stream; and
a spray nozzle configured to discharge the outlet stream.

34. The sprayer body of claim 33, wherein the cartridge comprises:
a first liquid contained within the cartridge;
a first end having a first diameter, configured to be removeably connected to the sprayer body,
a second end having a second diameter and located opposite the first end wherein the second end is located in a position above the first end when the cartridge is connected to the sprayer body such that gravity exerts a downward force on the first liquid to pull the first liquid towards the first end;
the first end comprising:
a bore extending axially from the first end and having a diameter less than the first diameter and comprising a first set of external threads, the bore defining a fluid flow path for the first liquid, wherein a downstream direction is towards the first end and an upstream direction is towards the second end;
a secondary threaded closure being internally threaded for mounting over the first set of threads and being externally threaded for engagement with corresponding threads on the sprayer body or with corresponding threads on a closure cap, the secondary threaded closure having an aperture extending axially through a center bore that is coincident with the bore of the first end;
a check valve comprising a duckbill portion and an umbrella portion mounted in the bore and extending through the aperture, the duckbill portion comprising a path for the first liquid to flow through from the cartridge and the umbrella portion comprising an air flow path for cartridge venting;
a metering orifice disposed in the bore, within the secondary threaded closure and located in the fluid flow path downstream of the check valve;
a fluid filter disposed within the bore in the fluid flow path upstream of the metering orifice such that the fluid filter serves to filter the first liquid prior to the first liquid flowing through the metering orifice.

35. The sprayer body of claim 33, wherein the orifice is on a metering disc that is adjustable to select one of several orifice sizes.

36. The spraying device of claim 33, wherein the spray nozzle is rotatably adjustable to provide different spray patterns.

37. The spraying device of claim 36, wherein the spray patterns comprise: flat, jet, and shower.

38. The spraying device of claim 33, further comprising:
a hose coupler connected to the second conduit that includes an anti-siphon unit.

39. The spraying device of claim 38, wherein the hose coupler is capable of having an external hose mounted thereto for supplying the second liquid.
